(19) United States
(12) Patent Application Publication
(10) Pub. No.: US 2017/0068630 A1
(43) Pub. Date: Mar. 9, 2017

(54) RUNTIME DRIVE DETECTION AND CONFIGURATION

(71) Applicant: HEWLETT PACKARD ENTERPRISE DEVELOPMENT LP, Houston, TX (US)

(72) Inventors: Yovita Iskandar, Houston, TX (US); Patrick A Raymond, Houston, TX (US); Jerome Burbridge, Houston, TX (US); David G Carpenter, Houston, TX (US)

(73) Assignee: HEWLETT PACKARD ENTERPRISE DEVELOPMENT LP, Houston, TX (US)

(21) Appl. No.: 15/307,523

(22) PCT Filed: Jun. 30, 2014
(86) PCT No.: PCT/US2014/044853

§ 371 Date: Oct. 28, 2016

(51) Int. Cl. G06F 13/40; G06F 13/42

(52) U.S. Cl. CPC G06F 13/4022; G06F 13/4282; G06F 2213/0026

(57) ABSTRACT

Examples of runtime drive detection and configuration are disclosed. In one example implementation according to aspects of the present disclosure, a computer implemented method includes detecting, by a computing system, that a drive is connected to the computing system during a runtime using a sideband signal of the drive. The method further includes determining, by the computing system, a drive type for the drive. Additionally, the method includes configuring, by the computing system, during a runtime, a PCIe multiplexer based on the determined drive type.

### BACKGROUND

As computing systems such as laptops, desktops, smart phones, tablets, and other similar computing devices become more popular, increasing amounts of data is generated and applications running on these computing systems utilize more data storage space. These computing systems often rely on various disk drives, which may be attached to the computing systems, to store the data, applications, and other information. As the amount of data and the variety and diversity of disk drives have increased, so too have the demands for system performance and flexibility increased.

### BRIEF DESCRIPTION OF THE DRAWINGS

The following detailed description references the drawings, in which:

FIG. 1 illustrates a block diagram of a computing system for detecting and configuring drives during runtime according to examples of the present disclosure;

FIG. 2 illustrates a flow diagram of a method for detecting and configuring a drive during runtime according to examples of the present disclosure; and

FIG. 3 illustrates a flow diagram of a method for detecting and configuring a drive during runtime according to examples of the present disclosure.

### DETAILED DESCRIPTION

Many computing systems utilize a variety of disk drives, optical drives, and the like for providing data, storage, and computer executable instructions to the computing systems. These drives may connect to the computing systems in a variety of ways, including parallel advanced technology attachment (PATA), serial advanced technology attachment (SATA), small computer system interface (SCSI), fiber channel, peripheral component interconnect (PCI), peripheral component interconnect express (PCIe), among others.

In a computing system, a PCIe switch device can be utilized to arbitrate communication between the computing system's processing unit and multiple PCIe drives. Currently, the PCIe switch port configuration to the PCIe drive bays may not be reconfigured during runtime since the connection is hard wired. Consequently, the PCIe drives cannot be dynamically swapped from one type of drive to another during runtime (i.e., during a time in which the computing system is powered on and operational). For example, a PCIe drive using four lanes of PCIe bus cannot be dynamically swapped for a PCIe drive using a dual two-lane PCIe bus during runtime of the computing device. Moreover, limited numbers of configurations are possible because the drive bays are hard wired.

Previously, some computing systems supplied only drive bays that can contain a single end device (one four-lane device or one-two lane devices). Moreover, computing systems desiring to support dual two-lane drives utilized a secondary PCIe switch within the drive bay to split a four-lane signal into two two-lane signals. However, some drive bay configurations may not allow for the additional switch circuitry within the drive bay due to physical restraints. Additionally, current computing systems may not be designed with the ability to have varied configuration during runtime, “hot plug,” events.

Various implementations are described below by referring to several examples of runtime drive detection and configuration. In one example implementation according to aspects of the present disclosure, a computer implemented method includes detecting, by a computing system, that a drive is connected to the computing system during a runtime using a sideband signal of the drive. The method further includes determining, by the computing system, a drive type for the drive. Additionally, the method includes configuring, by the computing system, during a runtime, a PCIe multiplexer based on the determined drive type.

In some implementations, the techniques described for drive detection and configuration provide for drive insertion and/or swapping during power-up and/or runtime. Mixing of various drive types is possible without any ordering (i.e., a single four-lane drive or dual two-lane drives). Further, drives, such as PCIe drives can be added and/or removed without impact to the current port ID without necessitating a system restart. In this way, drives can be added and/or removed in a variety of different configurations without impact to the host computing system. For example, it may be possible to remove one type of drive and replace it with a different type of drive (or different configuration of drives) without a system restart. These and other advantages will be apparent from the description that follows.

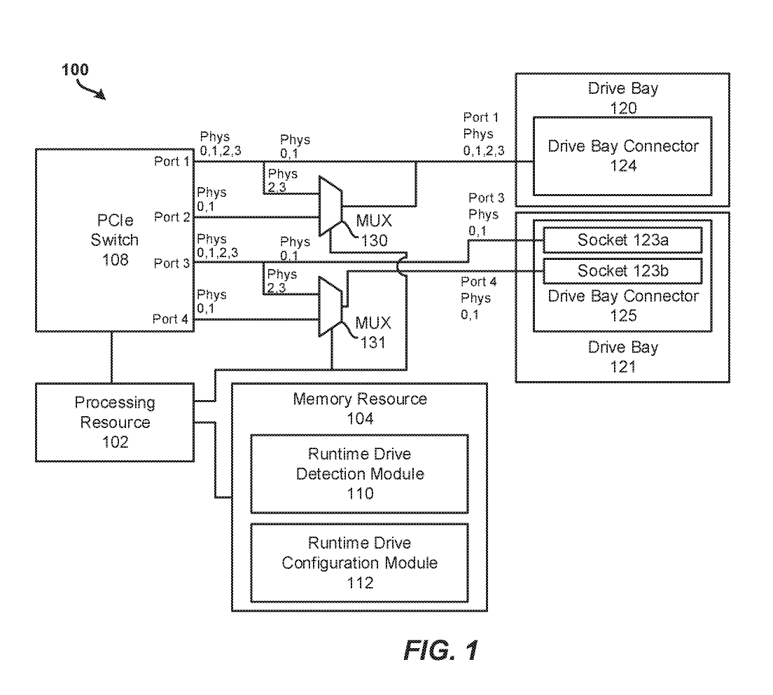

FIG. 1 illustrates a block diagram of a computing system 100 for detecting and configuring drives during runtime according to examples of the present disclosure. FIG. 1 includes particular components, modules, etc. according to various examples. However, in different implementations, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these.

It should be understood that the computing system 100 may include any appropriate type of computing device, including for example smartphones, tablets, desktops, laptops, workstations, servers, smart monitors, smart televisions, digital signage, scientific instruments, retail point of sale devices, video walls, imaging devices, peripherals, or the like, or any appropriate combination thereof.

The computing system 100 may include a processing resource 102 that represents generally any suitable type or form of processing unit or units capable of processing data or interpreting and executing instructions. The instructions may be stored on a non-transitory tangible computer-readable storage medium, such as memory resource 104, or on a separate device (not shown), or on any other type of volatile or non-volatile memory that stores instructions to cause a programmable processor to perform the techniques described herein. Alternatively or additionally, the computing system 100 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein. In some implementations, multiple processors may be used, as appropriate, along with multiple memories and/or types of memory.

In addition to the processing resource 102 and the memory resource 104, the computing system 100 includes a peripheral component interconnect express (PCIe) switch 108 having a number of ports (e.g., port 1, port 2, port 3, and port 4). Each of the ports may support a certain number of PCIe lanes, such a single lane (x1), dual lane (x2), four lane (x4), eight lane (x8), sixteen lane (x16), and the like. As the number of PCIe lanes on a particular port increase, the bandwidth for data transfer so too increases. The PCIe switch 108 may support a variety of different port and lane configurations, depending on the manufacturer and model of PCIe switch implemented. In the example shown, the PCIe switch 108 implements two ports of x4 lanes (ports 1 and 3) and two ports of x2 lanes (ports 2 and 4). Other configurations of ports, lanes and lanes/port are possible. The PCIe switch 108 is communicatively coupled via a wired connection to drive bay connectors 124 and 125 in drive bays 120 and 121 respectively. More particularly, in the example shown in FIG. 1, ports 1 and 2 of the PCIe switch 108 are communicatively coupled to drive bay connector 124 through a multiplexer such as MUX 130. Similarly, ports 3 and 4 of the PCIe switch 108 are communicatively coupled to drive bay connector 124 through a multiplexer such as MUX 131.

The MUX 130 and MUX 131 select an appropriate one of several input signals and forward the selected input into a single output of the respective multiplexer. In examples, the MUX 130 and MUX 131 may be any suitable type of PCIe multiplexer or passive multiplexer. The connections between processing resource 102 and MUX 130 and between processing resource 102 and MUX 131 represent the select signal used to select between the inputs from port 1 and from port 2 (for MUX 130) and from port 3 and port 4 (for MUX 131). The output of the MUX 130 is transmitted to drive bay connector 124 while the output of the MUX 131 is transmitted to drive bay connector 125, depending upon the drive configuration.

Additionally, the computing system 100 includes a runtime drive detection module 110 and a runtime drive configuration module 112. In one example, the modules described herein may be a combination of hardware and programming. The programming may be provided by processor executable instructions stored on a tangible memory resource such as memory resource 104, and the hardware may include processing resource 102 for executing those instructions. Thus memory resource 104 can be said to store program instructions that when executed by the processing resource 104 implement the modules described herein. Other modules may also be utilized as will be discussed further below in other examples. It should be understood that “runtime” generally refers to the time during which the computing system 100 is executing programmatic instructions to cause the computing system to perform certain functions.

The runtime drive detection module 110 detects the presence of a drive in drive bays 120 and 121 connected to drive bay connectors 124 and 125 respectively. The runtime drive detection module 110 may detect the presence of the drive by using sideband signals transmitted by the drive to the processing resource 102. The drives may include all suitable forms of storage mechanisms including hard disk PCIe drives, solid state PCIe drives, flash memory PCIe drives, magnetic disk PCIe drives, and other similar types of PCIe drives. In examples, the drives may include SFF-8639 and/or M.2 compliant drives. The runtime drive detection module 110 then determines the drive type of the drives in drive bays 120 and 121. For example, the runtime drive detection module 110 may utilize the sideband signals or other information to determine that a two-lane PCIe drive, a four-lane PCIe drive, or another type of drive is connected to the computing system 100.

Once the runtime drive detection module 110 detects the presence of the drive and determines the drive's drive type, the runtime drive configuration module 112 then configures the MUX 130 and/or the MUX 131. In an example, as illustrated in FIG. 1, the MUX 130 receives signals from port 1 of the PCIe switch 108 representative of two lanes of a four-lane PCIe channel. More specifically, the four-lane PCIe channel is bifurcated into two separate two-lane channels, the first channel being designated phys 0,1 and the second channel being designated phys 2,3. Phys 0,1 of port 1 bypass the MUX 130 while phys 2,3 of port 1 lead into an input of MUX 130. Similarly, two lanes of port 2 (phys 0,1) also lead into an input of MUX 130.

Similarly, the MUX 131 receives signals from port 3 of the PCIe switch 108 representative of two lanes of a four-lane PCIe channel. More specifically, the four-lane PCIe channel is bifurcated into two separate two-lane channels, the first channel being designated phys 0,1 and the second channel being designated 2,3. Phys 0,1 of port 3 bypass the MUX 131 while phys 2,3 of port 3 lead into an input of MUX 131. Similarly, two lanes of port 4 (phys 0,1) also lead into an input of MUX 131. It should be noted that, in the example illustrated, ports 1 and 3 represent four-lane PCIe channels and ports 2 and 4 represent two-lane PCIe channels. However, any suitable combination of lanes and channels may be implemented without deviating from the nature of the present disclosure, and the example of a two-lane and a four-lane channel should not be construed as limiting.

In the example shown, four PCIe lanes are passed to the drive bay connectors 124 and 125. However, which lanes are passed depends on the drive configuration within each of the drive bays 120 and 121. For example, if a four-lane (x4) PCIe drive is inserted into the drive bay 120, the runtime drive detection module 110 may determine that the drive is a x4 drive (for example, by using sideband signals). The MUX 130 is then configured by the runtime drive configuration module 112, through the select line from the processing resource 102, to pass the two-lane PCIe channel from port 1 (i.e., phys 2,3 of port 1) to the drive bay connector 124 of drive bay 120. In this configuration, the x4 drive receives and transmits data via each of the four lanes of port 1 (i.e., phys 0,1,2,3).

In another example, if dual two-lane (2 x2) PCIe drives are inserted into the drive bay 121 and connected to drive bay connector 125, the runtime drive detection module 110 may determine that the drives are dual x2 drive (for example, by using sideband signals). The drive bay connector 125 may utilize dual PCIe sockets 123a and 123b to accommodate the dual x2 drives. The MUX 131 is then configured by the runtime drive configuration module 112, through the select line from the processing resource 102, to pass the two-lane PCIe channel from port 4 (i.e., phys 0,1 of port 4) to PCIe socket 123b. In this way, the x2 drive connected to PCIe socket 123a transmits and receives data via two of the lanes of port 3 (i.e., phys 0,1 of port 3). The second x2 drive can then transmit and receive data via the two lanes of port 4 (phys 0,1 of port 4). In this configuration, each of the two x2 PCIe drives is communicatively coupled to a corresponding two ports of the PCIe switch 108 (e.g., the x2 drive connected to PCIe socket 123a is communicatively coupled to port 3 of PCIe switch 108 and the x2 drive connected to PCIe socket 123b is communicatively coupled to port 4 of PCIe switch 108).

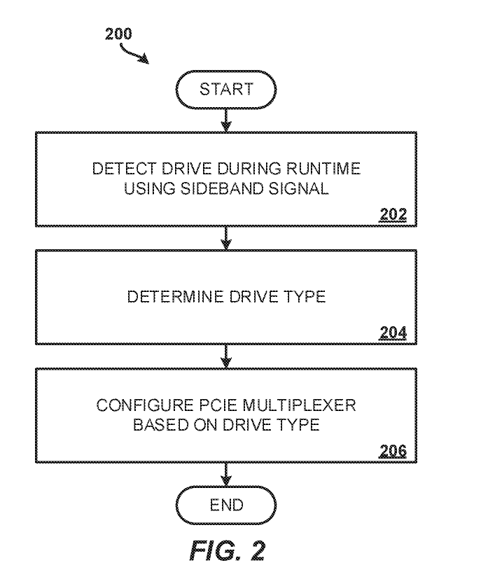

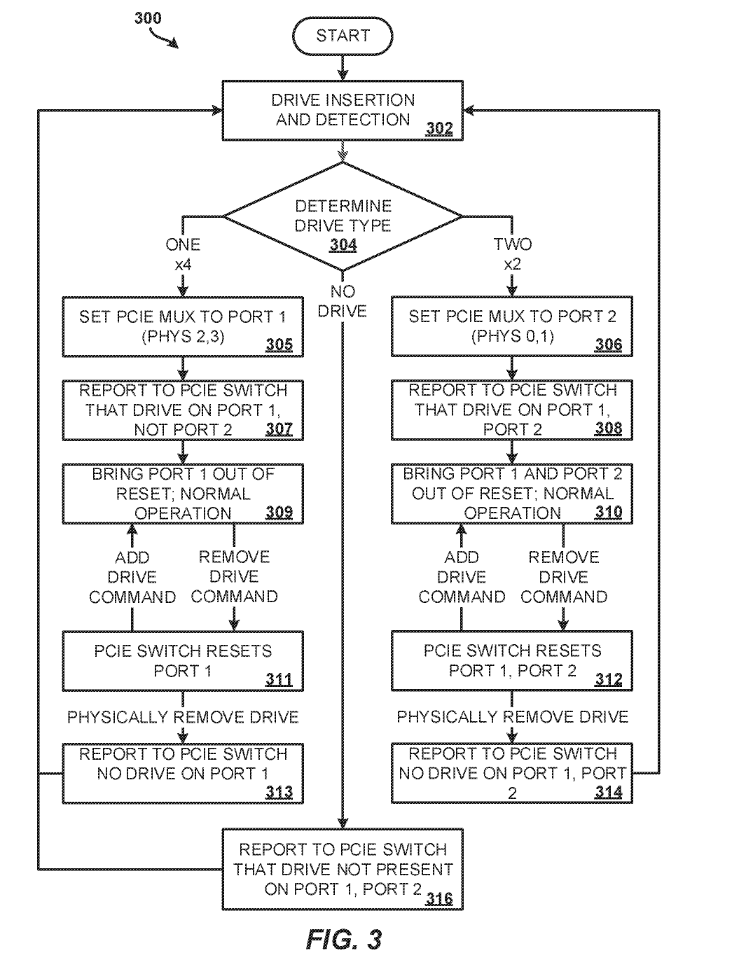

It should be understood that the computing system 100 of FIG. 1 may implement the methods 200 and 300 described in more detail below regarding FIGS. 2 and 3. It should be further understood that either drive bay 120 or drive bay 121 may accommodate either single x4 drives or dual x2 drives through the utilization of PCIe sockets with the drive bay connectors. The socket to connector conversion may be performed through a separate physical integrated circuit card or through an integrated circuit built into the drives or drive carrier holding the drives.

FIG. 2 illustrates a flow diagram of a method 200 for detecting and configuring a drive during runtime according to examples of the present disclosure. The method 200 may be executed by a computing system or a computing device such as computing system 100 of FIG. 1 or may be stored as instructions on a non-transitory computer-readable storage medium that, when executed by a processor, cause the processor to perform the method 200. In one example, the method 200 may include: detecting a drive during runtime using a sideband signal (block 202); determining a drive type (block 204); and configuring a PCIe multiplexer based on the drive type (block 206).

At block 202, the method 200 includes detecting a drive during runtime using a sideband signal. For example, the method 200 may include a computing system (e.g., computing system 100 of FIG. 1) detecting that a drive is connected to the computing system during a runtime using a sideband signal of the drive. Detecting that a drive is connected may occur as a result of a hardware signal being passed from the attached drive to the computing system using sideband signals in an example. In other examples, other detection procedures may be implemented, such as querying the drive to detect the drive, or other suitable methods. The method 200 continues to block 204.

At block 204, the method 200 includes determining a drive type. For example, the method 200 may include a computing system (e.g., computing system 100 of FIG. 1) determining a drive type for the drive. A drive type indicates the connection configuration of the drive. For example, the drive type may indicate that a particular drive is a four-lane (or x4) PCIe drive. In another example, the drive type may indicate that a particular drive is a two-lane (or x2) PCIe drive. The method 200 continues to block 206.

At block 206, the method 200 includes configuring a PCIe multiplexer based on the drive type. For example, the method 200 may include a computing system (e.g., computing system 100 of FIG. 1) configuring, during a runtime, a PCIe multiplexer (e.g. MUX 130 and/or MUX 131 of FIG. 1) and based on the determined drive type.

In an example in which the drive type is a four-lane (or x4) PCIe drive, the PCIe multiplexer is configured to pass two lanes of a four-lane PCIe channel between a four-lane port of the PCIe switch and the four-lane PCIe drive. In an example in which the drive type is dual two-lane (or 2 x2) PCIe drives, the PCIe multiplexer is configured to pass two PCIe lanes between a first port of the PCIe switch and a first two-lane PCIe drive and to pass a second two lanes between the second port of the PCIe switch and a second two-lane PCIe drive.

Additional processes also may be included. For example, the computing system may detect that a second drive is connected to the computing system during the runtime using a sideband signal of the second drive. It may then be determined, by the computing system, a second drive type for the second drive, and the computing system may then configure the PCIe multiplexer based on the determined second drive type during the runtime. In an example in which the second drive type is a two-lane PCIe drive, the PCIe multiplexer passes one port of two-lane width between the two-lane PCIe drive and a second port of the PCIe switch.

Further, the computing system may detect the removal of the drive during runtime and, in response, configure the PCIe multiplexer based on the removal of the drive.

It should be understood that the processes depicted in FIG. 2 represent illustrations, and that other processes may be added or existing processes may be removed, modified, or rearranged without departing from the scope and spirit of the present disclosure.

FIG. 3 illustrates a flow diagram of a method 300 for detecting and configuring a drive during runtime according to examples of the present disclosure.

The method 300 may be executed by a computing system or a computing device such as the computing system 100 or may be stored as instructions on a non-transitory computer-readable storage medium that, when executed by a processor, cause the processor to perform the method 300.

At block 302, the method 300 includes a drive being inserted (i.e., connected) to a computing system, such as the computing system 100 of FIG. 1 and detected by the computing system. For example, the method 300 may include the computing system detecting that the drive is connected to the computing system during a runtime using a sideband signal of the drive. Detecting that a drive is connected may occur as a result of a hardware signal being passed from the attached drive to the computing system using sideband signals in an example. In other examples, other detection procedures may be implemented, such as querying the drive to detect the drive, or other suitable methods.

At block 304, the method 300 includes determining a drive type for the drive. For example, the method 300 may include a computing system determining a drive type for the drive. A drive type indicates the connection configuration of the drive. For example, the drive type may indicate that a particular drive is a four-lane (or x4) PCIe drive. In another example, the drive type may indicate that a particular drive is a two-lane (or x2) PCIe drive.

If it is determined at block 304 that one four-lane (x4) drive is connected to the computing system, one port of the PCIe switch is used. Specifically, at block 305, the method 300 includes setting the PCIe multiplexer (such as MUX 130 and/or MUX 131 of FIG. 1) to receive the input from port 1 (phys 2,3) of the PCIe switch (such as PCIe switch 108 of FIG. 1) and propagate those physical lanes (phys 2,3 of port 1 for example) to the drive bay connector. At block 307, the method 300 includes reporting to the PCIe switch that the drive is receiving signals via port 1, not port 2. This may be accomplished, for example, using sideband signals. At block 309, the method 300 includes bringing port 1 of the PCIe switch out of reset (i.e., causing port to go high) such that data can be transmitted via port 1 of the PCIe switch. During this period (i.e., when port 1 is out of reset), the drive may be used normally. That is, the computing system may access the drive by reading, writing, and modifying data on the drive. If a user initiates a drive removal procedure or command, such as by pressing a button on the drive or selecting a drive removal option in software of the computing system, the PCIe switch resets port 1 (i.e. causes port 1 to go low) such that data is no longer transmitted via port 1 of the PCIe switch (block 311). If a drive is selected to be added, the method 300 may bring port 1 out of reset again (at block 309) and the drive may begin normal operation. If a drive is physically removed, it may be reported to the PCIe switch that no drive is present on port 1 (block 313). At this point, the method 300 may proceed back to drive insertion and detection (block 302).

If it is determined at block 304 that two two-lane (x2) drives are connected to the computing system, two ports of the PCIe switch are used. Specifically, at block 306, the method 300 includes setting the PCIe multiplexer (such as MUX 130 and/or MUX 131 of FIG. 1) to receive the input from port 2 of the PCIe switch (such as PCIe switch 108 of FIG. 1) and propagate those physical lanes (phys 0,1 of port 2 for example) to the drive bay connector. At block 308, the method 300 includes reporting to the PCIe switch that the drive is receiving signals via port 1 (for the first x2 drive) and port 2 (for the second x2 drive). This may be accomplished, for example, using sideband signals. At block 310, the method 300 includes bringing port 1 and port 2 of the PCIe switch out of reset (i.e., causing port 1 and port 2 to go high) such that data can be transmitted via port 1 and port 2 of the PCIe switch. During this period (i.e., when ports 1 and 2 are out of reset), the drives may be used normally. That is, the computing system may access the drives by reading, writing, and modifying data on the drives. If a user initiates a drive removal procedure or command, such as by pressing a button on the drive or selecting a drive removal option in software of the computing system, the PCIe switch resets port 1 and port 2 (i.e. causes port 1 and port 2 to go low) such that data is no longer transmitted via port 1 or port 2 of the PCIe switch (block 312). If a drive is selected to be added, the method 300 may bring port 1 and port 2 out of reset again (at block 310) and the drive may begin normal operation. If a drive is physically removed, it may be reported to the PCIe switch that no drive is present on port 1 and port 2 (block 314). At this point, the method 300 may proceed back to drive insertion and detection (block 302).

If it is determined at block 304 that no drive is connected to the computing system, it is reported to the PCIe switch that no drive is present on port 1 or port 2 (block 316).

Additional processes also may be included, and it should be understood that the processes depicted in FIG. 3 represent illustrations, and that other processes may be added or existing processes may be removed, modified, or rearranged without departing from the scope and spirit of the present disclosure.

It should be emphasized that the above-described examples are merely possible examples of implementations and set forth for a clear understanding of the present disclosure. Many variations and modifications may be made to the above-described examples without departing substantially from the spirit and principles of the present disclosure. Further, the scope of the present disclosure is intended to cover any and all appropriate combinations and sub-combinations of all elements, features, and aspects discussed above. All such appropriate modifications and variations are intended to be included within the scope of the present disclosure, and all possible claims to individual aspects or combinations of elements or steps ore intended to be supported by the present disclosure.

What is claimed is:

1. A method comprising:
detecting, by a computing system, that a drive is connected to the computing system during a runtime using a sideband signal of the drive;
determining, by the computing system, a drive type for the drive; and
configuring, by the computing system, during a runtime, a PCIe multiplexer based on the determined drive type.

2. The method of claim 1, wherein the drive type is a four-lane PCIe drive, and wherein the PCIe multiplexer is configured to pass two lanes of a four-lane PCIe signal between a port of a PCIe switch and the PCIe drive, and wherein two additional lanes of the four-lane PCIe signal are passed directly between the port of the PCIe switch and the PCIe drive.

3. The method of claim 1, wherein the drive type is two of a two-lane PCIe drive, and wherein the PCIe multiplexer is configured to pass two lanes of a four-lane PCIe signal between a first port of the PCIe switch and the PCIe drive, and wherein two additional lanes of the four-lane PCIe signal are passed directly between a second port of the PCIe switch and the PCIe drive.

4. The method of claim 1, further comprising:
detecting, by the computing system, removal of the drive during the runtime.

5. A system comprising:
a drive bay having a drive bay connector to receive four lanes of a peripheral component interconnect express (PCIe) signal from a PCIe switch communicatively coupled to the drive bay connector via a PCIe multiplexer;
a drive detection module stored in a memory resource executable by a processing resource to detect that a drive is connected to the computing system during a runtime and to determine a drive type for the drive; and
a drive configuration module stored in the memory resource and executable by the processing resource to configure, during the runtime, the PCIe multiplexer based on the determined drive type.

6. The system of claim 5, wherein the drive bay connecter further includes a first socket and a second socket, wherein the four lanes of the PCIe signal is bifurcated into a first two-lane signal directed to the first socket and a second two-lane signal directed to the second socket.

7. The system of claim 5, further comprising:
a backplane to communicatively couple the drive bay to the computing system.

8. The system of claim 5, wherein the drive detection module detects that the drive is connected to the computing system during a runtime using a sideband signal of the drive.

9. The system of claim 5, further comprising:
a second drive bay having a third socket and a fourth socket, the sockets to receive at least one drive.

10. The system of claim 9,
wherein a PCIe switch is communicatively coupled to the third and fourth sockets via a second PCIe multiplexer, and
wherein the drive configuration module further configures, during the runtime, the second PCIe multiplexer.

11. A non-transitory computer-readable storage medium storing instructions that, when executed by a processor, cause the processor to:
determine a drive type during a runtime;
configure a peripheral component interconnect express (PCIe) multiplexer during the runtime according to the drive type; and
report to a PCIe switch that the drive is present on a particular port based on the drive type.

12. The non-transitory computer-readable storage medium of claim 11, further comprising instructions to:
bring the particular port of the PCIe switch out of reset in response to the drive being added.

13. The non-transitory computer-readable storage medium of claim 12, further comprising instructions to:
reset the particular port of the PCIe switch in response to the drive being removed.

14. The non-transitory computer-readable storage medium of claim 13, further comprising instructions to:
reporting to the PCIe switch that the drive is not present in response to the drive being removed.

15. The non-transitory computer-readable storage medium of claim 11, wherein the determining a drive type during a runtime utilizes sideband signals of the drive.
